(19) United States
(12) Patent Application Publication
(10) Pub. No.: US 2026/0201641 A1
(43) Pub. Date: Jul. 16, 2026

(54) NOVEL WHEAT MILLING DERIVATIVE PRODUCTS, METHODS OF MAKING AND USES OF THE SAME

(71) Applicant: ARCHER-DANIELS-MIDLAND COMPANY, Decatur, IL (US)

(72) Inventors: Ali Ayoub, Decatur, IL (US); Matt Kaloupek, Decatur, IL (US); Morgan Malm, Decatur, IL (US)

(21) Appl. No.: 19/134,672

(22) PCT Filed: Dec. 4, 2023
(86) PCT No.: PCT/US2023/082301

§ 371 Date: May 30, 2025

Related U.S. Application Data
(60) Provisional application No. 63/386,029, filed on Dec. 5, 2022.

(51) Int. Cl. D21H 17/29; D21H 17/22; D21H 27/10

(52) U.S. Cl. CPC D21H 17/29; D21H 17/22; D21H 27/10

(57) ABSTRACT

Novel wheat milling derivative products obtained from one or more non-food wheat milling products are described, as well as methods for making the same. The wheat milling derivative products enable up to 15% by weight of cellulosic fibers in paper or in paper packaging to be displaced, diminishing the negative environmental impacts heretofore associated with the making of these paper and paper packaging products and thus improving the sustainability of these paper and paper packaging products, and derive from non-food wheat milling products already realized in conventional wheat milling.

### TECHNICAL FIELD

The present invention relates generally to wheat milling, and more particularly to the use of wheat milling products in other than consumable or food-/feed-related contexts.

### BACKGROUND OF THE INVENTION

The particular non-consumable or non-food/feed related context of interest for the present invention is sustainable paper and paper packaging. Sustainable packaging design has become increasingly important over the past few years, as consumers become more focused on the environment.

Traditionally, pulp for paper and paper packaging has been derived from trees. With a growing awareness however of the negative environmental impacts of certain aspects of paper manufacturing, for example, in relation to deforestation and the loss of important wildlife habitats as well as protections against erosion, the use of enormous amounts of energy and water, water pollution and air pollution, a number of efforts have been undertaken to improve the sustainability of the paper and paper packaging industries. One such effort has involved the use of recycled virgin fibers in old corrugated container (OCC) material.

However, OCC frequently requires repulping and de-inking processes which causes the recycled fibers to get weakened over time through successive recycles. The result is a deterioration of critical performance requirements such as strength (compression, grammage, burst, ash retention, internal bond potential, and tensile), moisture resistance and freeze/thaw tolerance. Consequently, a variety of alternative, non-wood fibers have recently been evaluated for displacing virgin wood fibers from trees. These alternative, non-wood fiber sources—for example, bagasse from sugar cane refining, hemp and wheat straw among others—are helpful to the extent they are able to function in place of virgin wood fibers from trees, but do not overcome or resolve other negative environmental impacts in that all still undergo the same energy- and water-intensive (and waste intensive) physical and chemical processing used in making paper and paper packaging from trees. Further, all require a certain amount of land to be devoted to their cultivation and sourcing rather than to food production of crops independent of their utility in providing fiber sources for paper and paper packaging, with all of the still-additional offsetting impacts involved in the collection of these materials in lieu of the collection of wood fiber from trees.

### SUMMARY OF THE INVENTION

The present invention relates in one aspect to the discovery that certain wheat milling products produced in the normal processing of wheat grain to make wheat flour for breads, pastas and the like can be used to make a suitable replacement material in displacement of virgin wood fibers in paper and paper packaging, with improved sustainability for the paper and paper packaging industries in light of the above-mentioned drawbacks and disadvantages of other alternative, non-wood finer sources such as bagasse, hemp and wheat straw. In this regard, “used” or “useful” in displacement of cellulosic fibers shall be understood to mean that the substitution of cellulosic fibers (virgin or recycled, as the case may be) with an alternative obtained by means of the present invention from the aforementioned wheat milling products from wheat milling as carried out in the usual course of making patent flour, in an equivalent amount by weight up to 15 percent by weight of the finished (dry) paper sheet or paper packaging product (or material), yet provides a paper or paper packaging product with commercially acceptable properties, resulting in less than a 20 percent reduction in any relevant finished paper or paper packaging material strength parameter—for example, in regard to paper sheet, the attributes of burst strength, internal bond strength or tensile strength. As will be evident from the working examples below, in a number of these parameters, it is possible by means of the present invention to realize paper sheet and paper packaging materials with very little to no reduction in measured values as compared to products made with no displacement of recycled or virgin cellulosic fibers and, indeed, even to see improvements in these values in certain of embodiments of the more environmentally sustainable paper sheet and paper packaging products provided by means of our invention.

It will of course be understood by those of skill in the art that the use of the above-referenced wheat milling products (as further characterized hereafter) in displacement of cellulosic fibers (whether virgin or recycled) does not by any means exclude the further displacement, in such paper sheet and paper packaging materials, of additional cellulosic fibers by means of other alternative, non-wood materials proposed in the art or newly developed—e.g., the bagasse, wheat straw and hemp already mentioned, or other wheat milling products including even such as patent flour or red dog.

As background, a wheat kernel is comprised of a number of constituent materials which are broadly classified in the milling literature under the categories of endosperm, bran, brush and germ. A typical wheat milling process employs an array of sorting, grinding, sieving and purification techniques to generate wheat flour, which is a highly purified endosperm fraction referred to by millers as flour or patent flour and which contains starch and varying levels of protein according to its intended use. Through the various grinding and sieving operations, the non-endosperm fractions are systematically fractured or ground and sieved out of the endosperm rich (flour) portion. Since this process occurs over many steps, multiple milling streams are typically produced, sometimes referred to as mill feed. Wheat millers may refer to these various milling streams as bran, shorts, red dog, or clear flour, and may further use the terminology bran, fine bran or coarse weatings, fine weatings or shorts, and low grade flour (red dog), though what is signified compositionally by all of these terms of art from one miller or indeed one mill to the next will vary to a degree, so that products or streams from one miller to the next or even from one mill to the next bearing the same descriptor will contain different fractions of endosperm, bran, brush, and germ from the wheat kernel. As well, some millers combine all these non-endosperm materials collected from various places, and will refer to the resulting combined product as “wheat midds” or “wheat middlings”.

Against this background, the wheat milling products with which the present invention is concerned in this first aspect are especially those non-endosperm-rich, non-patent flour products arising out of the normal processing of wheat grain to make wheat flour or patent flour for foodstuffs, and which may be called “wheat midds” or “wheat middlings” in the milling art, but which we will describe compositionally herein in relation to starch, fiber and protein content by weight percentages of what is obtained from a mill for purposes of making the paper and paper packaging compositions of the present invention—so that those of skill in the art will be able to understand with greater clarity the wheat milling products that the present invention employs (according to this first aspect) regardless of how those materials may be described by a particular miller or how and from which milling fractions the materials may be derived by a particular miller or in a particular mill. From this perspective, the wheat milling products with which the present invention is particularly concerned in this first aspect will comprise from 15 to 30 weight percent starch, from 30 to 40 weight percent fiber; and from 15 to 20 weight percent protein—though as already mentioned, the displacement of cellulosic fibers by materials made from the wheat milling products so characterized is not to be taken as excluding the further displacement in paper sheet or paper packaging compositions enabled by the present invention and containing cellulosic fiber alternative materials prepared from wheat midds, of additional cellulosic fibers by other non-wood alternatives, including even other wheat milling products, even those that are endosperm-rich and presently sold into consumable, food- or feed-related applications (such as patent flour).

As a reference point for those of skill in the milling art considering the potential sourcing of such a wheat milling product from a given mill, a variety of non-endosperm rich, non-patent flour wheat milling products were obtained from a number of mills in the United States under various commonly used mill descriptors and these were compositionally characterized, as follows:

| dry basis, % | | | | |
|---|---|---|---|---|
| ash | protein | starch | fat | carbs, excluding starch |

“Screenings”:

| | | | | | |
|---|---|---|---|---|---|
| average | 7% | 14% | 39% | 3% | 38% |
| Std dev | 2% | 2% | 2% | 0% | 3% |

“Shorts”:

| | | | | | |
|---|---|---|---|---|---|
| average | 6% | 20% | 19% | 5% | 49% |
| Std dev | 0% | 2% | 3% | 1% | 3% |

“Bran”:

| | | | | | |
|---|---|---|---|---|---|
| average | 7% | 18% | 18% | 5% | 52% |
| Std dev | 1% | 1% | 2% | 1% | 2% |

“Red dog”:

| | | | | | |
|---|---|---|---|---|---|
| average | 4% | 18% | 34% | 5% | 38% |
| Std dev | 1% | 2% | 13% | 1% | 10% |

“Clear Flour”:

| | | | | | |
|---|---|---|---|---|---|
| average | 2.7% | 20.5% | 58.4% | 4.4% | 14.0% |
| Std dev | 0.9% | 1.5% | 6.7% | 1.1% | 3.4% |

Thus, in this first aspect, the present invention relates to a novel wheat milling derivative product useful for displacing virgin wood fibers in paper or in paper packaging from a wheat milling product as characterized above and to a process for making the same, whereby the wheat milling derivative product is obtained by mechanically processing a non-endosperm rich, non-patent flour wheat milling product as characterized above by shearing, grinding/milling or a combination of shearing and grinding.

In one embodiment, the wheat milling product as characterized above compositionally is processed in or through a device that produces shear forces to produce a sheared pre-product, and the sheared pre-product is ground or milled to form the wheat milling derivative product.

A number of devices are known which could be used for producing the sheared pre-product, including for example, single, double and triple continuous screw extruders in any of their conventional configurations, ribbon and paddle blenders and the like, dependent on whether continuous, semi-continuous or batchwise operation is desired. Likewise, a variety of grinding devices and methods are known which could be employed to produce a wheat milling derivative product of the present invention, which we consider should have a mean particle size in the range of from 10 microns to 2200 microns in diameter.

In another embodiment, the present invention relates to a novel wheat milling derivative product as alternately made by mixing a non-endosperm rich, non-patent flour wheat milling product as characterized above with water to produce a wet wheat milling product mixture; processing the wet milling product mixture through a device that produces shear forces to produce a sheared pre-product; and grinding the sheared pre-product to form a wheat milling derivative product having a mean particle size in the range of from 10 microns to 300 microns in diameter.

In certain embodiments, the wheat milling derivative products made by a mechanical processing of a wheat milling product as previously described are not chemically or enzymatically modified, while in other, preferred embodiments the wheat milling derivative products have been formed by a method including a chemical or enzymatic modification step. Particularly contemplated are treatments, of the wheat milling product by exposure to an acid, alkali, enzyme, oxidizing agent, cationizing agent or any combination thereof prior to or in the course of the mechanical processing involved in producing a wheat milling derivative product from the wheat milling product, for example, prior to or in the course of carrying out the shearing of the wheat milling product to provide the sheared pre-product (that is then ground as needed to provide a wheat milling derivative product of the prescribed mean particle size range).

In a further aspect, the present invention relates to a method of making a paper sheet that comprises (a) providing a non-endosperm rich, non-patent flour wheat milling product comprising from 15 to 30 weight percent starch, from 30 to 40 weight percent fiber; and from 15 to 20 weight percent protein; (b) producing a wheat milling derivative product from at least a portion of the wheat milling product according to a process as described above, the wheat milling derivative product having a mean particle size in the range of from 10 microns to 300 microns in diameter; and (c) displacing at least some and up to 15 weight percent of cellulosic fibers from wood pulping with the wheat milling derivative product.

In another aspect, the present invention relates to a paper sheet or paper packaging in which a wheat milling derivative product of the present invention has been incorporated, particularly but without limitation in displacement of cellulosic fibers from wood pulping—as the wheat milling derivative products can be used equally to displace less sustainable non-wood alternatives to such cellulosic fibers, for example, from bagasse, hemp and wheat straw, as well as used alongside such other non-wood alternatives, including other wheat milling products and even including wheat milling products such as patent flour or red dog that have substantial food- or feed-related uses (as a paper or paper packaging manufacturer may desire).

The paper sheets and paper packaging products made at least in part using the wheat milling derivative products of the present invention may be used for paper towel applications, in carrier board, for tissues, napkins, wall paper, packaging paper, mailing, fluting, liner board, liquid packaging board, folding box board, chipboard, molded products and goods such as food trays and egg cartons.

These and other aspects, embodiments, and associated advantages will become apparent from the following Description of Embodiments of the Invention.

### DESCRIPTION OF EMBODIMENTS OF THE INVENTION

Before describing embodiments of the present invention in detail, it is understood that unless explained otherwise, all technical and scientific terms used herein have the same meaning as commonly understood to one of ordinary skill in the art to which this disclosure belongs. The materials, methods, and examples are illustrative only and not intended to be limiting.

As used in this specification, and the appended claims, the singular forms “a,” “an,” and “the” include the plural references and the term “comprising” means “including” unless the context clearly indicates otherwise. The term “or” refers to a single element of stated alternative elements or a combination of two or more elements unless the context clearly indicates otherwise. In the context of the present invention, the terms “and/or” includes any single elements as well as all possible combinations of the elements cited in the respective list. Unless defined otherwise in context, all technical and scientific terms used herein have their usual meaning, conventionally understood by persons skilled in the art to which the present invention pertains.

In the present application, unless otherwise indicated either explicitly or necessarily in context, all temperatures given are in degrees Celsius (degrees C.), while all percentages are on the basis of weight as compared to the relevant whole (wt %). Other abbreviations in this context include “N %” as the amount of nitrogen present in the material (on a dry solid basis), “DS” degree of substitution, “N/A” not analyzed, and “RE” reaction efficiency. The term “grinding” refers to mechanically breaking down the sheared pre-product into smaller components, whether by devices advertised or labeled as “grinders” or by other devices which will mechanically break down the sheared pre-product into smaller particle sizes. The term “pre-product” used herein refers to a product obtained prior to grinding. In the context of the present invention, “dry” means that less than 12% of free water is present in the composition the invention notwithstanding that a certain amount of water may nevertheless be bound within the particles of the composition. “Wood pulping” refers to pulp made of traditional methods such as acid modified, kraft, and other known methods to the industry. “Cellulosic fibers” shall be understood as comprising recycled pulp, dark kraft, or any combination thereof. Cellulosic fibers may be obtained from virgin or recycled pulp, a papermill, industrial waste, or paper streams rich in mineral fillers and cellulosic materials from a papermill.

As previously summarized, the present invention relates in one aspect to the use of certain wheat milling products comprising from 15 to 30 weight percent starch, from 30 to 40 weight percent fiber; and from 15 to 20 weight percent protein to make novel wheat milling derivative materials which can in turn be used in displacement of cellulosic fibers (both virgin and recycled) in the making of paper and paper packaging comprising such novel wheat milling derivative materials. Fortuitously, a typical wheat midds or wheat middlings fraction or stream will be of the prescribed character and can be mechanically processed to form a novel wheat milling derivative product suited for use in paper or paper packaging in displacement of cellulosic fibers.

In certain embodiments, the method of forming a wheat milling derivative product suited for displacement of cellulosic fibers in paper or paper packaging comprises: (a) mixing a wheat milling product of the prescribed composition and character with water, producing a wet wheat milling product mixture; (c) processing the wet wheat milling product mixture through a device that produces shear forces to produce a sheared pre-product; and (d) grinding the sheared pre-product to produce the wheat milling derivative product. In other embodiments, the wheat milling product is provided as-is to the shearing device to produce the sheared pre-product or to a grinding or milling device.

A variety of devices will be recognized by those of skill in the art as useful for the shearing of the wheat milling product or of a slurry of the wheat milling product in water, including thermomechanical devices such as an extruder. The extruder may comprise a screw configuration of a single screw, two or more co-rotating or counter-rotating screws, ram, or other similar extrusion methods as is known in the art. Other examples of suitable devices include mixers, such as paddle mixers or screw mixers, as well as blenders, kneaders, pelletizers, and pumps. Other processing methods may also be used including jet milling, milling, or a combination thereof. Processing may also be used with the introduction of air into the processing system including but not limited to cavitation. The elements of such devices, as well as the conditions used in the shearing of the wheat milling product or aqueous wheat milling product slurry (for example, through adding heat during the shearing), can be varied to modify the operating properties of the device and the properties of the products of the invention.

Subsequently the sheared pre-product can be broken apart by grinding, roll pressing, milling or similar mechanical action (or a combination of such devices) which have the effect of reducing the sheared pre-product to a smaller mean particle size material.

In some embodiments, the wheat milling product is first subjected to a chemical or enzymatic treatment prior to or in the course of mechanically processing the wheat milling product in neat form or as slurried with water. Particularly contemplated are treatments of the wheat milling product by exposure to an acid, alkali, enzyme, oxidizing agent, cationizing agent or any combination thereof, with exposure to an alkali or to a cationizing agent being particularly preferred. Suitable cationizing agents can be selected from among the group consisting of the amino ion-, imino ion-, sulfonium ion-, phosphonium ion-, ammonium ion-containing compounds and mixtures of such compounds.

As previously indicated, a paper or paper packaging product including the wheat milling derivative products of the present invention can be made in the same manner as currently conventionally practiced, with however displacing up to 15 percent by weight of the cellulosic fibers from wood pulping that would otherwise be used in these methods and in these paper and paper packaging products, as these cellulosic fibers are conventionally used and without any exceptional or extraordinary adjustments being necessary by reason of the substitution—certainly none that would be beyond the exercise of ordinary skill of those knowledgeable in the paper and paper packaging arts or as requiring anything other than routine optimization.

Consequently, the wheat milling derivative products of the present invention may be blended with those same additives and classes of additives conventionally known to those in the paper and paper packaging arts as useful from time to time in combination with the cellulosic fibers that our materials are displacing, including, for example, additives to enhance the strengthening properties of the paper sheet—including, but not being limited to, cationic starches, oxidized starches, and crosslinked starches from corn, rice, potato, pea and combinations of any thereof by way of non-limiting examples of plant sources—fillers, retention aids, sizing agents, wet and dry strength agents, defoamers, dyes, and pigments.

Other components may be added for example to achieve certain additional desired functional attributes in sustainable packaging incorporating the wheat milling derivative products of the present invention. Examples include essential oils, such as terpenes, as well as antibiotics, pharmaceuticals, enzymes, and flavors.

### EXAMPLES

The following examples are provided to further describe the embodiments presented herein but are offered as exemplary only and are not to be considered as limiting of the scope of what we have invented and contributed to the art, as more particularly defined by the claims which follow hereafter.

The wheat milling products used in the below Examples (all of the composition described herein for the wheat milling product starting materials) were obtained from Archer Daniels Midland Company processing facilities at Quincy, Illinois or Beech Grove, Indiana. The cationic reagent 3-chloro-2-hydroxypropyltrimethyl ammonium chloride (Quat 188, 60% solution) was obtained from Sigma Aldrich in St. Louis, MO. Terpene, d-limonene was obtained from Archer Daniels Midland Company in Winter Haven, Florida. Cationic corn starch was obtained from Archer Daniels Midland Company.

### Example 1

In this example, a twin screw extruder was used to generate a chemically modified wheat milling derivative product. Specifically, the processor had twin screws (each having a length of 17 inches and a diameter of 2 inches) in a high shear configuration including conveying and mixing elements. First, 0.39 mols of sodium hydroxide as a 19% w/w solution in water was sprayed onto 0.5 kg of wheat milling product which had a moisture content of 7%. After mixing for 10 minutes, 0.15 mols of 3-chloro-2-hydroxypropyltrimethyl ammonium chloride was sprayed onto the mixture as a 60% w/w solution in water (Sigma Aldrich). The mixture was continuously fed into the entrance of the twin screw extruder at a rate of 40 grams per minute with additional water, via peristaltic pump, to bring the moisture content of the mixture to 40% w/w. The mixture was processed with the steam jacket at 19 psi and a screw speed of 40 RPM. Material exited the extruder through its 43 mm diameter exit at 66 degrees C., and was collected and dried at 40 degrees C. overnight. A 20% dry solids solution of this material in water was then prepared and neutralized with 10% HCl (v/v) to pH 6.5. This neutralized mixture was then blended on high (in an Oster home blender) with 600 mL of 200 proof ethanol for 5 minutes and vacuum filtered with Whatman filter paper (#54). The filter cakes were air dried and evaluated for N %, while the corresponding DS was calculated to be 0.05.

### Example 2

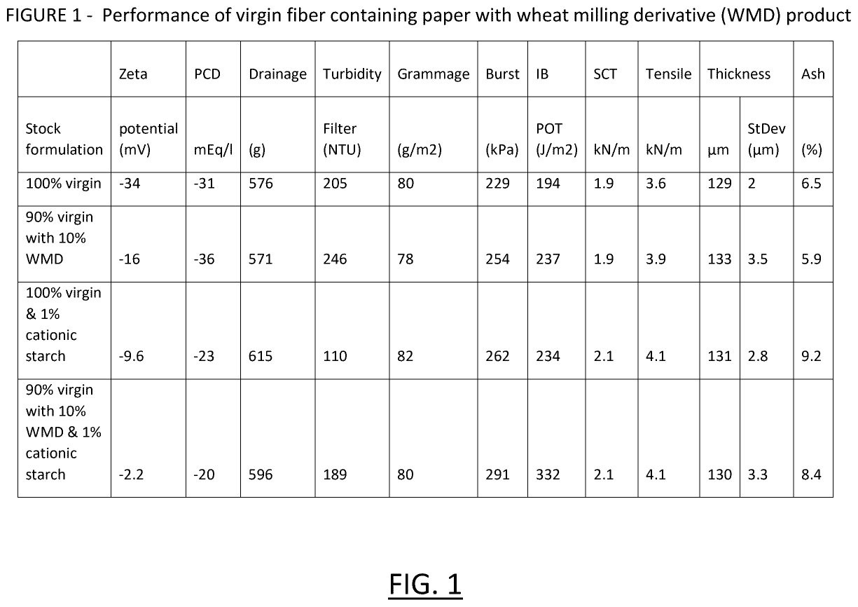

The material prepared in Example 1 was milled through a 0.5 mm sieve at 12000 RPM. For the control paper, 88 grams of virgin paper was cut into 5×5 cm squares and these were added to the pulper. For the experimental papers incorporating a wheat milling derivative product according to the present invention, a portion of the virgin paper was replaced by the sieved material. Tap water (2 L) at 40° C. was added to the pulper in each iteration (resulting in a 4% pulp, labeled thickstock). The pulper was run for 5 minutes at 1400 rpm. The thickstock was transferred to an equalizer and further diluted with tap water to a total of 8 kg (resulting in a 1% pulp, labeled thinstock). The thinstock was homogenized for 5 min and then split into two equal portions (4 kg). Each portion was placed in an equalizer. One portion was used as is to produce hand sheets, while cooked cationic starch was added to the other portion at a final concentration of 1%. This process was repeated for papers wherein in excess of 10% by weight of the virgin paper had been replaced with the sieved material (8.8 grams sieved material with 79.2 grams virgin paper). Wet and dry end performance was evaluated and reported in FIG. 1, where the reported values were determined by means of the following instruments and methods:

### Wet End Tests:

Zeta Potential—The thinstock (1% consistency) was placed into the measurement cup (500 mL) of a SZP-10 Zeta Potential system (BTG Mutek). The suction tube is lowered, and the streaming potential of the pulp was measured with alternating vacuum pressure. The zeta potential is read from the device after the end point is reached.
Drainage—Drainage was measured using a DFR-05 (BTG Mutek) with a sample size of 1000 mL thinstock.
Turbidity—For turbidity measurements, 15 mL of filtered (100 μm pore size) thinstock is measured using a Hach—2100Q at 860 nm.
PCD—For particle charge demand measurements, 10 mL of filtered (100 μm pore size) thinstock is measured using a BTG Mutek PCD-04. The solution is titrated with either a negative or positive titrant, specifically 0.001 N PES-Na or 0.001 N Poly-Dadmac. The titration endpoint is reported as the charge demand.

### Dry End Tests:

Grammage—The weight of handsheets are measured on an analytical scale, while the thickness of each sheet was measured on 4 points over the surface of the sheet (Wolf—DM2000P). Grammage was calculated as a basis of grams per sq. meter, reported as an average of 4 replicates.
Burst strength—One sheet per series is selected and tested on Burst strength. To determine the burst strength, a handsheet is placed on the Burst measuring meter (L&W Bursting Strength Tester SE180) and the measurement is started. The process is repeated for six replicates and averaged.
Ash retention test—The ash retention test is performed by placing a sample of the handsheet into a ceramic cup. The cup is ashed for 2 hours at 525 C (Nabertherm—P330), removed from oven, and placed into a desiccator until cooled. Ash is calculated as a percent of the ashed handsheet weight compared to the initial weight of the handsheet.
SCT—short span compression test—also known as STFI. The short span compression test was done on 16 mm wide strips using a L&W Compressive Strength Tester, modified from TAPPI T826. Three measurements were made per strip and values are reported as an average of six measurements.
Tensile Strength—Tensile strength was measured using L&W—Tensile Tester SE062, following ISO 1924-3 where the width between the clamps were modified to 10 cm. A 16 mm wide strip is placed in the measurement device and aligned in the sample clamps, and the test is run. Results are reported as an average of 5 measurements.
Internal Bond—TAPPI T569 method was used to evaluate the internal bond of the samples (Emco Internal Bond Tester), with strips sized at 2.54 cm wide. Values are reported as an average of 5 measurements.

### Examples 3 and 4

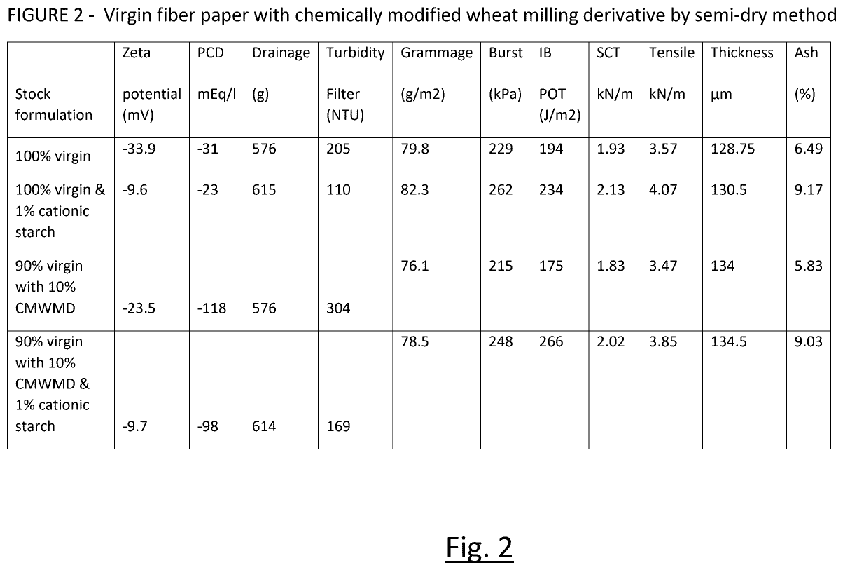

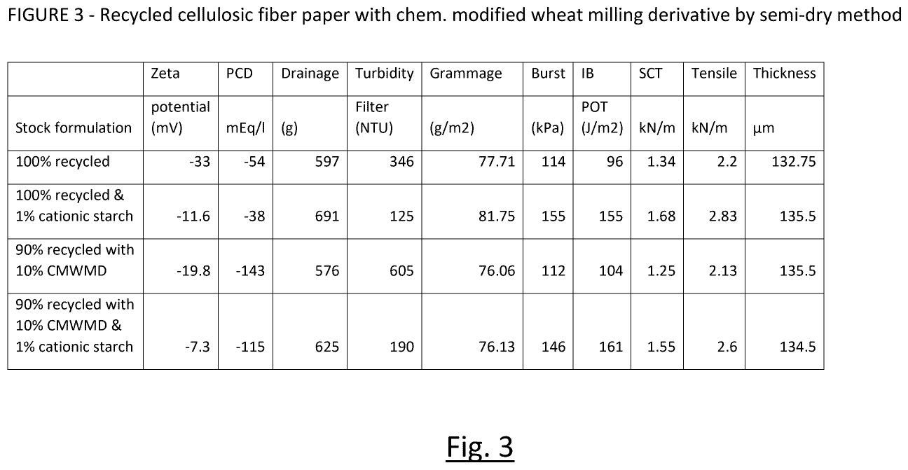

A wheat milling product (510 grams, 8% moisture) was sprayed first with 0.41 mols of sodium hydroxide (18.6% w/w solution) and then with 0.15 mols of 3-chloro-2-hydroxypropyltrimethyl ammonium chloride (60% w/w solution). The mixture was homogenously mixed (20% moisture), placed in a sealed container, and placed in a laboratory oven at 85 degrees C. for 24 hours. Half of the mixture was removed from the container after 6 hours of heating, and the second half was removed at 24 hours. DS was measured as described in Example 1, with 6 hours resulting in a DS of 0.027 and 24 hrs resulting in 0.029. Stock solutions and papers were thereafter prepared and evaluated as in Example 2, using the same instruments and methods, to evaluate the utility of the chemically modified wheat milling derivative product made in this example for displacing virgin cellulosic fiber in a paper sheet product and then for displacing recycled fiber in a recycled paper fiber, paper sheet product. Results from that evaluation are shown in FIGS. 2 and 3, respectively, for the paper sheets made using virgin fiber and recycled fiber.

### Examples 5 and 6

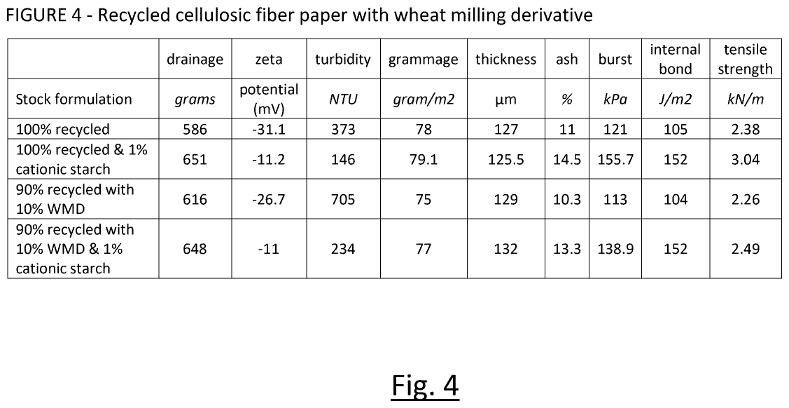

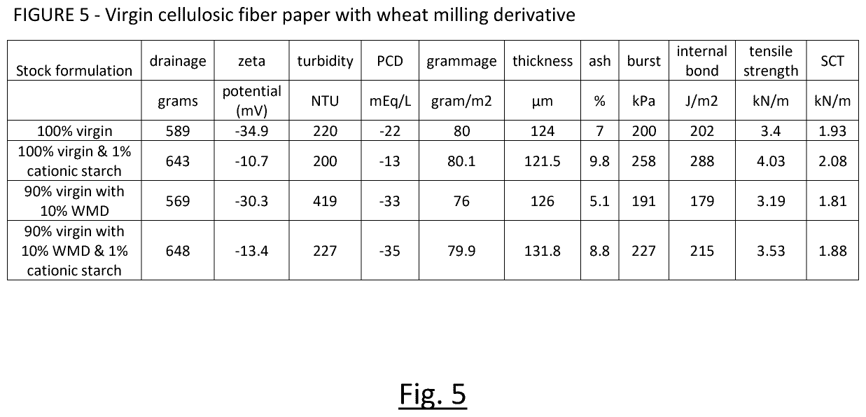

Paper sheet products compromised of recycled and virgin cellulosic fibers were prepared with portions of a wheat milling derivative product prepared as in Example 1, except that the wheat milling derivative product was however not chemically modified with the 3-chloro-2-hydroxypropyltrimethyl ammonium chloride in the manner of Example 1. The papers were made and evaluated as in Examples 2, 3 and 4 and using the methods and equipment described therein. The results of the evaluations are found in FIGS. 4 and 5, respectively, for the recycled and virgin fiber-based paper sheet products including the wheat milling derivative product.

### Examples 7 and 8

A twin screw extruder was used to modify and for the continuous production of two cationic (chemically modified) wheat milling derivative product samples under two different barrel moisture conditions. Wheat milling product was fed into a top loading hopper of a Wenger X52 Extruder System. The wheat milling product was fed into a preconditioner at a rate of 52.1 kg/hr, with 50% w/w sodium hydroxide at a rate of 3.2 kg/hr. As the combined mixture was fed into the extruder, the cationic reagent (1-Propanaminium, 3-chloro-2-hydroxy-N,N,Ntrimethyl-, chloride, 65% w/w) was injected at a rate of 4.37 Kg/hr. Moisture content of the barrel was 30% in one instance, 40% moisture in the other with additional water injected. Temperature of the barrel reached up to 220 degrees F. based on mechanical energy, screw configuration, and circulating jacket temperatures of the extruder. The extruded product was then dried to a moisture content less than 15% by weight and milled to a mean particle size less than 800 microns. Degree of substitution was determined by N % incorporation, with the starting material's N % serving as N % initial. The degree of gelatinization was evaluated via polarized light microscopy for the presence of maltese crosses, indicative of uncooked crystalline starch structures. More specifically in relation to this microscopic evaluation, 1 gram of a sample was diluted with 40 mL of deionized water and mixed with the water using a benchtop vortex mixer. The samples were then stained using 1000 μL of N/50 iodine solution. Approximately two drops of the mixed, cationic wheat milling derivative product solution were added to a microscope slide via transfer pipette, including as many visible particulates as possible. Images were then taken with polarized light, using an optical microscope (Leica DM2700M) in 20×/0.40 objective.

The results of the analysis are reported below in Table 1.

TABLE 1

| | Barrel Moisture | | Gelatinization |
|---|---|---|---|
| Sample | (%) | DS | (microscopy) |
| Cationic Wheat Milling | 30% | 0.037 | low |
| Derivative #1 | | | |
| Cationic Wheat Milling | 40% | 0.039 | high |
| Derivative #2 | | | |

### Examples 9 and 10

Using each of the cationic wheat milling derivative products produced and characterized as described above in Examples 7 and 8, 100 gsm recycled cellulosic fiber papers were produced and evaluated as in previous examples, displacing 10 percent by weight of the recycled cellulosic fibers with each of the cationic wheat milling derivative products. The effect of the wheat milling derivative fibers on the wet and dry properties of the papers were evaluated and the measured values are reported below in Table 2 as a percent change from the 100% recycled fiber control paper.

TABLE 2

| | | | Burst | | | |
|---|---|---|---|---|---|---|
| | Zeta | Basic | (Normal- | Scott | Short Span | Tensile |
| Sample | Potential | Weight | ized) | Bond | Compression | Strength |
| Cationic | 54% | −3% | 2% | 13% | −4% | 2% |
| Wheat | | | | | | |
| product #1 | | | | | | |
| Cationic | 65% | −3% | 19% | 15% | 4% | 4% |
| Wheat | | | | | | |
| product #2 | | | | | | |

### Examples 11 and 12

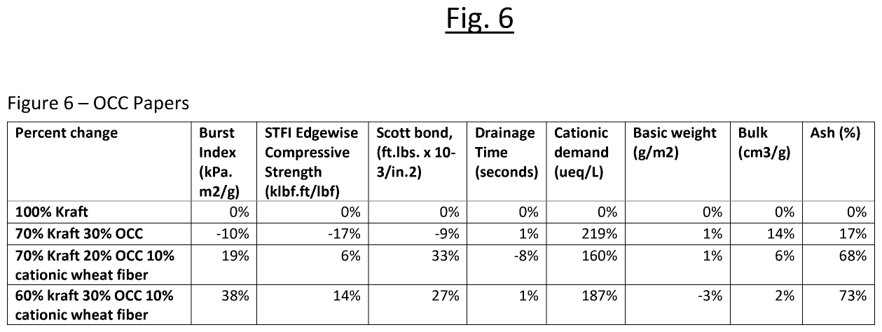

In these examples, paper products were prepared having a final paper composition in one instance of 60% kraft wood pulp, 30% OCC wood pulp, and 10% cationic wheat milling derivative fiber product and in a second instance 70% kraft wood pulp, 20% OCC wood pulp and 10% cationic wheat milling derivative fiber product. After producing the cationic wheat milling derivative fiber product according to the same process and using the same equipment as used in Example 8 (i.e., at the 40% barrel moisture figure), the resultant wheat milling derivative fiber product was dry blended with powdered citric acid to a neutral pH. 4% consistency stock solutions were then prepared from the various pulp sources in the proportions described, hydropulped at 40 degrees Celsius for 5 minutes, and subsequently mixed and diluted to a final 0.3% consistency. 120 gsm handsheets were then prepared following TAPPI Standard Method T205 and compared to controls omitting the cationic wheat milling derivative product following the same handsheet process. Wet and dry end properties were evaluated for all handsheets following TAPPI Standards (T-227 for drainage, T 807 for burst, T-826 for STFI edgewise compressive strength, T 569 for Scott bond, T 211 for ash). Cationic charge determinations were performed on a Mutek PCD-05. For the charge determinations, the cationic polyelectrolyte used was polydimethyl diallyl ammonium chloride (poly-DADMAC), 0.01 N and the anionic polyelectrolyte was sodium polyethylene sulphonate (PES-Na), 0.01 N from BTG. Pipette or weigh 10 g of the sample into the sample cell. Insert the sample cell in the instrument. Place the burette tip above the test portion surface, wait for about 1 min, and start the titration. The time between the titrant additions should be at least 30 s. At the neutral point when mV=0, record the amount of titrant used in meq/1. Percent changes as reported in FIG. 6 are calculated based from the 100% Kraft control.

### Example 13

Cationic wheat milling derivative fiber product was produced using a B&P Littleford batch, bench scale mixer with steam jacket. Wheat milling product was first milled to a particle size less than 500 microns (63% w/w, 13% moisture) and then dry blended with sodium hydroxide (2% w/w). After the material was mixed for at least 10 minutes, 1-Propanaminium, 3-chloro-2-hydroxy-N,N,Ntrimethyl-, chloride was added via spraying a fine mist at 5% w/w (65% aqueous solution). Additional moisture was added to bring the final moisture content to 40% w/w, and the mixture was mixed and brought to an internal temperature of 150 degrees Fahrenheit. The reaction was held at this condition for 5 hours with constant mixing (at 45 hz). The material was thereafter collected, cooled, washed and characterized for degree of substitution by monitoring N % incorporated. Considering the N % of unwashed raw wheat fiber milling product prior to the reaction, 0.35% N was incorporated after a reaction time of 5 hours, which corresponds to a DS of 0.042.

1. A wheat milling derivative product useful for displacing cellulosic fibers in paper or paper packaging, comprising from 15 to 30 weight percent starch, from 30 to 40 weight percent fiber; and from 15 to 20 weight percent protein from wheat and characterized by a mean particle size in the range of from 10 microns to 2200 microns in diameter.

2. A chemically or enzymatically modified wheat milling derivative product as produced by exposure of a wheat milling derivative product as otherwise defined in claim 1 to an acid, alkali, enzyme, oxidizing agent, cationizing agent or any combination thereof.

3. A chemically or enzymatically modified wheat milling derivative product according to claim 2, wherein the exposure to an acid, alkali, enzyme, oxidizing agent, cationizing agent or any combination thereof takes place in a process of forming the wheat milling derivative product from a wheat milling product of the recited composition.

4. A modified wheat milling derivative product according to claim 2, wherein the exposure is to an alkali or cationizing agent.

5. A modified wheat milling derivative product according to claim 4, wherein the exposure is to a cationizing agent selected from among the group consisting of the amino ion-, imino ion-, sulfonium ion-, phosphonium ion-, ammonium ion-containing compounds and mixtures of such compounds.

6. A paper sheet or paper packaging product comprised of cellulosic fibers and from greater than 0 to 15 percent by weight of a wheat milling derivative product as defined in claim 1 or of a chemically or enzymatically modified wheat milling derivative product as defined in any of claims 2-5.

7. A paper sheet or paper packaging product according to claim 6, further comprising at least one other non-wood material in the form of bagasse, wheat straw, hemp or another wheat milling product.

8. A paper sheet or paper packaging product according to claim 7, wherein the another wheat milling product is patent flour, red dog or is a combination of these.

9. A process of making a wheat milling derivative product useful for displacing cellulosic fibers, comprising:
obtaining a wheat milling product comprising from 15 to 30 weight percent starch, from 30 to 40 weight percent fiber; and from 15 to 20 weight percent protein; and
subjecting the wheat milling product to mechanical processing
to provide a wheat milling derivative product characterized by a mean particle size in the range of from 10 microns to 2200 microns in diameter.

10. A process as defined in claim 9, further comprising mixing the wheat milling product with water to produce a wet wheat milling product mixture, and wherein the mechanical processing comprises subjecting the wheat milling product in the form of the wet wheat milling product mixture to shearing forces to provide a sheared pre-product in the presence of water and grinding or milling the sheared pre-product to provide the wheat milling derivative product.

11. A process according to claim 10, further comprising adding an acid, alkali, enzyme, oxidizing agent, cationizing agent or any combination thereof to a) the wheat milling product of claim 10 prior to its mixing with water or b) in respect of claim 10 to the wet wheat milling product mixture, and in either of a) or b) as the case may be, either prior to subjecting the same to the mechanical processing.

12. A process according to claim 11, wherein a cationizing agent is added.
